(19) United States
(12) Patent Application Publication
(10) Pub. No.: US 2025/0373019 A1
(43) Pub. Date: Dec. 4, 2025

(54) METHOD AND APPARATUS FOR THE POWER SUPPLY OF A STEEL PLANT

(71) Applicant: DANIELI AUTOMATION S.P.A., BUTTRIO (UD) (IT)

(72) Inventors: Antonello MORDEGLIA, BANGKOK (TH); Francesco FABRIS, PALMANOVA (UD) (IT); Andrea POLO, SAN GIOVANNI AL NATISONE (UD) (IT); Scheila MARCUZZI, REMANZACCO (UD) (IT)

(21) Appl. No.: 18/868,824

(22) PCT Filed: May 22, 2023
(86) PCT No.: PCT/IT2023/050127

§ 371 Date: Nov. 25, 2024

(30) Foreign Application Priority Data
May 31, 2022 (IT) 102022000011573

(51) Int. Cl. H02J 3/30; F27B 1/26; H02J 1/10

(52) U.S. Cl. CPC H02J 3/30; F27B 1/26; H02J 1/102; H02J 2300/20; H02J 2310/18

(57) ABSTRACT

A method for supplying electric energy in a steel plant including at least a furnace for melting metal material and one or more user devices that use the metal material obtained from the at least one furnace which are electrically powered by a power supply including at least one transformer connected to an electric network and a power supply system located downstream of the transformer.

### FIELD OF THE INVENTION

The present invention concerns a method and an apparatus for the power supply of a steel plant for the treatment of metal material.

An example of a steel plant, to which particular reference will be made in the following description, is a steel plant comprising at least one of either a line for melting the metal material and a line for rolling the metal material.

### BACKGROUND OF THE INVENTION

As is known, in a steel plant, the line for melting the metal material is provided with at least one melting furnace, for example an electric arc furnace or an induction melting furnace, a casting line and at least one rolling line, where the metal material obtained by melting is sent to be rolled. Normally, the melting line also provides a refining furnace and possibly vacuum treatment stations for the liquid metal.

The rolling line can receive the molten material from a continuous casting process of the metal material, which passes from a ladle to a mold and then to a roller way which transfers the metal material toward rolling stands, provided with motorized rolling rolls or toward storage plates.

Downstream of the roller way and upstream of the rolling stands, the rolling line generally comprises one or more heating furnaces, for example induction furnaces, able to heat the metal material coming from the continuous casting line, or from external plates, in a uniform manner, before rolling.

Both in the melting line and also in the rolling line, there are various user devices which absorb high quantities of electric energy, in the order of tens of megawatts/hour, for example the melting and refining furnaces, the drive means for the rolls of the rolling stands, the heating furnaces, the roller ways for transferring the metal material, and others.

The steel plant is therefore continuously connected to the electric network and the absorption of three-phase alternating electric current is a function of production, therefore the greater the molten material produced by the furnace, the greater the amount of electric energy to be purchased, with the risk that the inconstancy of the electricity consumption generates disturbances in the network which have to be compensated for by means of special inductances which are burdensome from an economic point of view, in order to avoid incurring penalties.

Another disadvantage is that the consumption of electric energy can be expensive, particularly in some geographical areas, or it can become so following important socio-economic events, also considerably increasing the supply costs.

Many steel plants are therefore forced, for example, to concentrate production during the periods in which the electric energy supplied by the electric network has a lower cost, for example at night.

Moreover, in the event of possible blackouts in the electric network, it is necessary to stop the plant and production, with consequent losses in productivity and therefore delays in the delivery of production batches.

There are apparatuses for the power supply of steel plants which are able to solve these problems by using one or more alternative energy sources able to supply power in addition, or as an alternatively, to the electric energy supplied by the electric network, in particular a public electric network.

However, these steel plants suffer from problems relating above all to disturbances relating to the absorption of power especially by the melting furnace and possibly by the user devices provided in the rolling line. For example, the furnace and user devices at certain times could require excessive amounts of power from the alternative energy sources and at other times the amount of power supplied by the alternative energy sources could be excessive.

In other words, the trend of the power absorbed by the furnace and/or by the user devices could have an excessively oscillatory trend over time, in which the difference between successive peaks and troughs in said trend, or between a trough and a peak, can even be 300 MW or more.

In the case, for example, of using an electric arc furnace, in the melting line, in the initial stages of penetrating the metal charge, the arc length between the electrodes and the scrap loaded into the furnace varies suddenly in proportion to the penetration of the electrodes into the scrap. This is a delicate moment, since it is necessary to be careful to avoid extinguishing the arc and breaking the electrodes due to slipping of the scrap.

This arc length, a function of the variable distance between the scrap and electrodes, is clearly proportional to the power absorbed by the furnace from the power supply apparatus; this power, absorbed in a variable manner, therefore creates imbalances in the supply from the traditional electric network, or from alternative energy sources, if provided, therefore in general from the energy sources that supply it.

The electric arc furnace is typically powered by an alternating current line provided with an inverter, and it may happen that the power absorption downstream of the inverter, especially in the initial melting phases, is not constant and this stresses the power supply apparatuses and/or the electric network.

For example, it is known that during a melting cycle of metal material intervals are normally provided for switching off the electrodes, so that the power absorbed by the furnace abruptly drops to zero; conversely, when they are turned on again the power grows rapidly.

In some moments, therefore, the power supplied by the energy sources will be optimal, and immediately afterwards it could be insufficient or excessive, so the technical problem that every steel plant has to face is to reconcile a more or less constant production, perhaps characterized by a plurality of different energy sources that contribute to powering different user devices, each with its own production cycles.

At times when it is not necessary to draw energy from the network, it is usually necessary to abruptly interrupt the absorption of energy from the network, whereas when there is a demand for power, the absorption of energy from the network becomes considerable. It follows that the overall power absorbed by the plant has an excessively oscillatory trend, which can generate disturbances and imbalances in the plant and also in other users of the network.

This oscillatory trend is also harmful if alternative energy sources are used in combination with the electric network to power the plant.

Document WO 2021/234751 A1 describes a power supply apparatus in an industrial plant for treating materials. The plant comprises one or more lines for treating the materials and one or more user devices powered with alternating current by means of power supply means comprising at least one transformer connected to an electric network and a power supply system located downstream of said transformer. The electric energy supply means also comprise at least one alternative energy source provided upstream of said power supply system and able to supply final energy to said one or more lines for treating materials and/or to said one or more user devices in addition to, or alternatively to, the electric energy supplied by said electric network, in particular a public electric network.

This apparatus also provides an energy storage system which is useful, for example, in compensating for the typical discontinuity of alternative or renewable energy sources that are used, for example photovoltaic or wind power plants.

However, this apparatus does not provide a power compensation system configured to absorb at least part of the energy delivered by the electric network when the furnace and/or the one or more user devices require from said electric network a power lower than a given value in order to maintain the power absorbed from the electric network within a range of the given value.

Therefore, the apparatus according to WO 2021/234751 A1 does not provide a compensation system able to absorb any excess energy delivered by said electric network.

This apparatus therefore does not allow dynamic compensation of any inconstant absorption of power by the furnace and/or other user devices of the steel plant, so as, for example, to reduce the voltage and/or current peaks of the power absorbed, or to compensate for any lack of power supplied by the alternative energy source.

Furthermore, this apparatus does not allow to maintain in an optimal manner the overall power absorbed from the side of the electric energy supply network substantially constant, independently of the process phases.

There is therefore a need to perfect a method and an apparatus for the power supply of a steel plant which can overcome at least one of the disadvantages of the state of the art.

In particular, one purpose of the present invention is to perfect a method for the power supply of a steel plant by means of which it is possible to effectively supply the furnace and/or other user devices present in the steel plant with the power required in a given phase of the production process, maintaining the overall power absorbed by the plant from the side of the electric energy supply network substantially constant, independently of the process phases.

Another purpose of the present invention is to perfect a method for the power supply of a steel plant which allows to dynamically compensate for any inconstant absorption of power by the furnace and/or the other user devices of the steel plant, so as, for example, to reduce the voltage and/or current peaks of the power absorbed, or to compensate for any lack of power supplied by the alternative energy source.

Another purpose of the present invention is to perfect a method for the power supply of a steel plant by means of which it is possible to make the alternative energy sources, if provided, work regularly and without excessive disturbances.

Another purpose of the present invention is to perfect a method for the power supply of a steel plant by means of which it is possible to store at least the energy supplied by possible sources of renewable energy during the power-off phases of the furnace and/or of the other user devices, and possibly supply it to other user devices and/or storage systems.

Another purpose of the present invention is to provide an apparatus for the power supply of a steel plant able to implement this method efficiently.

Another purpose of the present invention is to provide a steel plant provided with an electric energy supply apparatus, at least one of either a melting furnace or one or more user devices that use the material produced by said furnace.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, the present invention concerns a method for supplying electric energy in a steel plant, comprising at least one of either a furnace for melting metal material or one or more user devices that use the metal material obtained from the at least one furnace, which are electrically powered by means of power supply means comprising at least one transformer connected to an electric network and a power supply system located downstream of the transformer.

The method provides to:
control, by means of a control system, the power absorbed from the electric network by the at least one furnace and/or by the one or more user devices;
electrically connect the power supply system to a power compensation system, comprising at least one storage system and at least one other user device and configured to absorb energy when the furnace and/or the one or more user devices require, from the electric network, a power lower than a given value, in order to keep the power absorbed from the electric network within a range of the given value, then absorb the possible excess energy delivered by the electric network.

By means of this power compensation system, the present method allows to effectively power the furnace and/or the other user devices present in the steel plant with the necessary power as a function of the requirement of a given phase of the production process, keeping the total power absorbed by the plant from the side of the electric energy supply network substantially constant, regardless of the process phases.

Therefore, when the power absorbed by the plant is equal to that required for a certain process phase, the power will be entirely used by the furnace and/or the user devices; while when the power required is lower than a given value, in order to avoid fluctuations in the power absorbed, at least part of the energy delivered by the network will be diverted toward the power compensation system.

Similarly, when the power required by the furnace and/or by the user devices increases again, the part of energy delivered which had previously been diverted toward the power compensation system can be once again supplied to the furnace and/or to the user devices.

Thanks to the power compensation system, which allows to divert the excess energy between one user device and the other, it is also possible to reduce the respective power-on times, since the time required to “move” the electric energy is considerably lower than that necessary to power-on a user device starting from a value of electric energy supplied by the electric network equal to zero.

According to one aspect of the present invention, the method provides to progressively divert the energy fed to the at least one furnace and/or to the one or more user devices toward the power compensation system.

According to another aspect of the present invention, the method provides to control the operation of the at least one furnace and/or of the one or more user devices on the basis of a predefined operating model that defines at least one or more operating phases, possible shutdown instants and the electrical power required for the one or more operating phases. In particular, the method provides to start to divert the energy fed to the furnace and/or to the user devices at a determinate time interval in advance of one or each of the shutdown instants.

According to another aspect of the present invention, the method provides to decrease the energy fed to the furnace according to a predefined ramp-down, and at the same time increase the energy fed to the compensation system according to a ramp-up that has a trend at least equal and opposite to the ramp-down.

According to another aspect of the invention, the at least one furnace is part of at least one melting line and the one or more user devices are part of a rolling line.

According to another aspect of the invention, the storage system is electrically connected to a common bus associated with direct current connection systems which are electrically connected to the at least one furnace and/or to the one or more user devices.

According to another aspect of the invention, electric energy is supplied to the at least one furnace and/or to the one or more user devices by means of at least one alternative energy source, different and independent from the electric network.

According to another aspect of the invention, at least an amount of power is supplied, by means of the storage system, to the at least one furnace and/or to the one or more user devices so as to integrate the power supplied by the at least one alternative energy source.

According to another aspect of the invention, the other user device is an electrolyzer configured to produce hydrogen and preferably send it to heating or melting furnaces, or to a reactor configured to produce iron by means of direct reduction reaction (DRI—Direct Reduced Iron).

According to another aspect of the invention, the pre-reduced iron is sent into the at least one melting furnace as charge material, in partial or total replacement for the scrap.

The invention also concerns an apparatus for supplying electric energy in a steel plant comprising at least one of either a furnace for melting metal material or one or more user devices that use the metal material obtained from the at least one furnace, which are electrically powered by means of power supply means comprising at least one transformer connected to an electric network and a power supply system located downstream of the transformer, wherein the apparatus comprises a control system configured to control the power absorbed from the electric network by the at least one furnace and/or the one or more user devices, and a power compensation system comprising at least one storage system and at least one other user device and configured to absorb energy when the furnace and/or the one or more user devices require a power lower than a given value, in order to keep the power absorbed within a range of a given value, then absorb the possible excess energy delivered by the electric network.

According to another aspect of the invention, the storage system comprises one or more storage devices connected to the common bus by means of a corresponding high frequency converter.

According to another aspect of the invention, the storage system is static, and the storage devices comprise batteries, fuel cells, supercapacitors or suchlike.

According to another aspect of the invention, the storage system is dynamic, and the storage devices comprise flywheel energy storage (FES) batteries, turbogenerators powered by renewable fuels such as palm oil, mini-hydro turbines or suchlike.

The invention also concerns a steel plant comprising at least one power supply apparatus and at least one furnace for melting metal material, and one or more user devices that use the metal material obtained from the at least one furnace.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a diagram of an electric power supply apparatus in a plant for treating metal material according to the present invention;

FIG. 2 is a graph that shows the trend of the power absorbed from the network by a furnace during melting and in the case of loading several baskets with and without a compensation system according to the invention;

FIG. 3 is a graph that shows the trend of the power fed to the furnace in accordance with the method according to the invention;

FIG. 4 is a graph that shows the trend of the power fed to a power compensation system, for example a storage system according to the invention.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

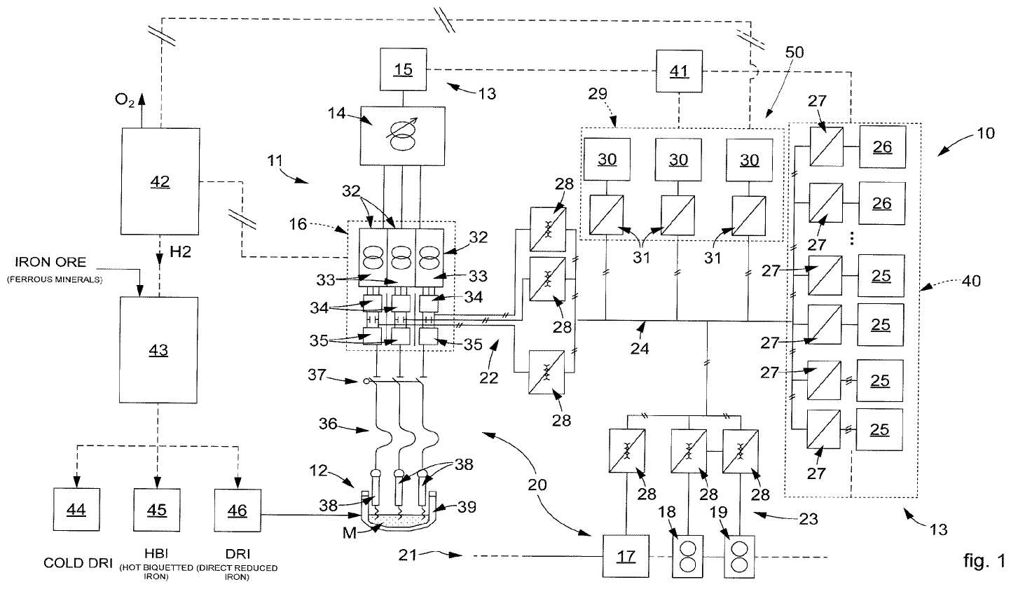

With reference to the attached drawings, see in particular FIG. 1, a steel plant 20 comprises at least one of either a furnace 12 for melting metal material or one or more user devices 17, 18, 19 that use the metal product obtained from the furnace 12. The at least one furnace 12 and/or the one or more user devices 17, 18, 19 are powered in alternating current by means of power supply means 13 comprising at least one transformer 14 connected to an electric network 15 and a power supply system 16 located downstream of the transformer 14.

The furnace 12 is part of a melting line 11, while the one or more user devices 17, 18, 19 are part of a rolling line 21.

The method for the power supply of the steel plant 20 according to the present invention provides to:
control, by means of a control system 41, the power absorbed from the electric network 15 by the at least one furnace 12 and/or by the one or more user devices 17, 18, 19;
electrically connect the power supply system 16 to a power compensation system 50 configured to absorb energy when the furnace 12 and/or the one or more user devices 17, 18, 19 require, from the electric network 15, a power lower than a given value, then absorb the possible excess energy delivered by the electric network.

The power compensation system 50 can comprise a storage system 29, another user device 42, a combination thereof, or other.

The method can provide to supply electric energy to the at least one furnace 12 and/or the one or more user devices 17, 18, 19 by means of at least one alternative energy source 40, different and independent from the electric network 15.

The method can also provide the connection of the at least one alternative energy source 40 to the at least one furnace 12 and/or to the one or more user devices 17, 18, 19 by means of direct current connection systems 22, 23 associated with a common bus 24, also called DC-Link.

The alternative energy source 40 can also be electrically connected, by means of the common bus 24, to the power compensation system 50, in the example case to a storage system 29, which can therefore be recharged using the energy supplied by the at least one alternative energy source 40.

In order to control the oscillations in the trend of the power generated by the alternative energy source 40 and possibly compensate for any lack of power supplied thereby, the storage system 29 can supply at least an amount of power to the at least one furnace 12 and/or the one or more user devices 17, 18, 19. This amount of power is therefore used to supplement the power supplied by the alternative energy source 40.

The alternative energy source 40 is therefore able to supply final energy to the furnace 12 and/or to the user devices 17, 18, 19 in addition, or as an alternative, to the electric energy supplied by the electric network 15, in particular a public electric network 15.

The power compensation system 50, thanks to the storage system 29, can therefore both receive and store the energy supplied by the alternative energy source 40 when it is not directly used by the furnace 12 and/or by the user devices 17, 18, 19, and also make it available later when required.

The storage system 29 can therefore act as a buffer able to receive and respectively supply electric energy as a function of requirements. The storage system 29 also allows to store any electric energy supplied by the electric network 15 when it is not used by the furnace 12 and/or by the user devices 17, 18, 19.

According to some embodiments, the furnace 12 can be an electric arc furnace or an induction melting furnace, for example. The furnace can be either a heating furnace used for melting metal material or a ladle furnace for refining it.

The user device 17 can be, for example, an induction furnace for heating the metal material along the rolling line 21. The user devices 18 and 19, on the other hand, can be for example the means that drive the rolls of the stands for rolling the metal material. The user devices could also comprise other elements, for example elements associated with the roller ways along which the metal product being rolled runs, and which are normally provided in the rolling line 21, or others.

The molten metal material produced by the furnace 12 of the line 11 could be transferred to the rolling line 21 by means of a continuous casting process, for example.

The direct current connection systems 22, 23 can be for example so-called DC Links or suchlike.

The alternative energy source 40 can comprise one or more renewable energy sources 25 and/or one or more non-renewable energy sources 26 able to supply electric energy in direct current or in alternating current.

As regards renewable energy sources 25, various technologies can be provided in this context, linked both to climatic/environmental parameters (sun, wind, hydrogeological morphology, etc.) as well as to the availability of other forms of energy obtainable through transformation (for example biomass, hydrogen, vegetable oil, etc.). Such renewable energy sources 25 can therefore comprise, for example, a hydroelectric plant, a wind farm, a solar photovoltaic plant or other.

The alternative energy source 40 can be a source of energy of the non-renewable type 26, for example deriving from the combustion of fossil fuels, such as oil, coal, or gas.

In order to achieve maximum use of the energy produced by the alternative energy source 40 provided, regardless of the solution adopted, it is preferable to create the common bus 24, to which all types of renewable 25 and/or non-renewable 26 energy sources which have been selected for use are connected, and from which the various direct current connection systems 22 and 23 which are connected to the common bus 24 can draw energy.

The provision of the common bus 24 therefore allows to connect several direct current power supply systems substantially to a single collector, which can also be advantageous for compensating load variations, reducing phenomena resulting from possible rapid variations in the power supply voltage, and other.

The direct current flowing in the common bus 24, shared by the various renewable or non-renewable energy sources 25, 26, is then distributed and suitably reconverted into alternating current, where necessary, at the site of the end user device, that is, for example, the furnace 12, the user devices 17, 18, 19 or other.

The common bus 24 can substantially be defined with a nominal value of direct voltage and a certain range of variation with respect to the nominal, linked to the variations of the rectified alternating current network.

This value may not be suitable for all the loads connected to the common bus 24, for example the furnace 12, the user devices 17, 18, 19 or others, therefore in these cases an adaptation of the direct voltage of the different existing direct current connection systems 22, 23 to the value of the voltage of the common bus 24 is required.

In order to allow the voltage adaptation, one or more high-frequency converters 27 are provided, in particular DC/DC converters, positioned between the common bus 24 and the alternative energy source 40.

By high frequency we mean the switching frequency of the switching devices; these converters 27 can be of the step-up/step-down type: the input direct current voltage, generated for example by a renewable energy source 25, such as photovoltaic or wind power, is raised or lowered at output from the converter 27, based on the voltage of the common bus 24.

A diagram of the converter 27 to be used could have a buck stage (step-down), a boost stage (step-up) and a high frequency (HF) transformer which guarantees the galvanic isolation between input and output; having several converters 27 connected on the same common bus 24 means that galvanic isolation may be necessary in order to prevent, in the event of a converter failure, the latter from propagating and blocking the user component or device, for example the furnace 12 of the melting line 11.

The same type of conversion can be provided in order to be able to connect the common bus 24 to the various direct current connection systems 22, 23 which are connected to the loads present in the steel plant 20.

Therefore, the present apparatus 10 can comprise one or more high-frequency converters 28, where galvanic isolation is necessary for the reasons already described for the converter 27, which are positioned between the common bus 24 and the direct current connection systems 22, 23.

The storage system 29 is electrically connected to the common bus 24 and can comprise one or more storage devices 30 connected to the common bus 24 by means of a corresponding high-frequency converter 31.

The storage system 29 can also be useful, for example, for compensating for the discontinuity typical of the renewable energy sources 25 that are used, for example photovoltaic or wind power plants, as well as compensating for the excessively wavelike trend of the power absorbed by the furnace 12 and/or by the user devices 17, 18, 19.

The storage system 29 can be static, therefore comprise storage devices 30 such as batteries, fuel cells, supercapacitors or other. Alternatively, or in combination, the storage system 29 can be dynamic, therefore comprise storage devices 30 such as flywheel energy storage (FES) batteries, turbogenerators powered by renewable fuels such as palm oil, mini-hydro turbines or other. The storage system 29 can be chemical, for example by means of systems for producing hydrogen by electrolysis, gas compression, hydrogen fuel cells or other.

The furnace 12, for example, will not always be in operation, so that the surplus of energy in the period in which it is powered off can be accumulated by means of one of the storage system 29 modalities described above.

The converters 27, 28 are preferably of the bi-directional type, that is, capable both of transferring energy to the load and also of recharging the storage system 29 when this falls below a minimum voltage threshold; if storage batteries are used, a Battery Monitoring System (BMS) management system can be integrated into the storage system.

In the event, for example, a photovoltaic plant is used as a renewable energy source 25, on the other hand, the converter 27, that is, the converter located on the side of the renewable energy source 25, has to optimize energy production always seeking the optimum working point.

The choice of one storage system over another depends on the type of application, based on whether it requires high power for a short period rather than lower power but for long periods, therefore significantly greater energy.

In the first case, supercapacitors are typically, but not only, applied, in the second case, flywheel batteries, batteries or other storage systems with high energy density are typically, but not only, applied. There are also applications which require a combination of the different solutions, where it is possible to have both high power delivery for short periods as well as a decidedly lower average energy value during the operating cycle.

As far as batteries are concerned, the power and energy density can vary considerably according to the technology to be adopted, for example AGM, Li-ion, Na—Ni, NaCl—Na or other.

Other storage systems 29 can also be used, such as for example gas compression in natural caverns, concentration photovoltaics, or others.

As regards the melting line 11, the power supply system 16 of the furnace 12 can comprise a plurality of power supply modules 32. Each of the power supply modules 32 comprises at least one medium voltage/medium voltage or medium voltage/low voltage transformer 33, a rectifier 34 connected to the transformer 33 and a converter 35 connected to the rectifier 34.

In accordance with one possible solution, the rectifiers 34 comprise devices, for example selected from a group comprising Diodes, SCR (Silicon Controlled Rectifier), GTO (Gate Turn-Off thyristor), IGCT (Integrated Gate-Commutated Thyristor), MCT (Metal-Oxide Semiconductor Controlled Thyristor), BJT (Bipolar Junction Transistor), MOSFET (Metal-Oxide Semiconductor Field-Effect Transistor) and IGBT (Insulated-Gate Bipolar Transistor), SiC (Silicon Carbide Semiconductor), GaN (Gallium Nitride Semiconductor).

In accordance with one possible solution, the converters 35 comprise devices selected, for example, from a group comprising SCR (Silicon Controlled Rectifier), GTO (Gate Turn-Off thyristor), IGCT (Integrated Gate-Commutated Thyristor), MCT (Metal-Oxide Semiconductor Controlled Thyristor), BJT (Bipolar Junction Transistor), MOSFET (Metal-Oxide Semiconductor Field-Effect Transistor), and IGBT (Insulated-Gate Bipolar Transistor), SiC (Silicon Carbide Semiconductor), GaN (Gallium Nitride Semiconductor).

The direct current connection system 22 is connected to each of the power supply modules 32 between the rectifier 34 and the converter 35.

Upstream of the melting furnace 12 there is also provided a high current circuit 36, which can be preceded by disconnector switches 37 for possible electrical disconnection.

The melting furnace 12, as mentioned, can be an electric arc furnace comprising a plurality of electrodes 38, each of which could be electrically powered by a corresponding power supply module 32. The metal material M to be melted can be contained inside a corresponding container 39 or vat. The electrodes 38 are configured to strike an electric arc through the metal material M and melt it.

The control system 41 is configured to monitor one or more parameters of either operating status, quality, quantity and/or cost of the electric energy available from the electric network 15 and from the at least one alternative energy source 40, and the amount of energy required by the one or more lines 11, 21 and/or by the one or more user devices 17, 18, 19, for example by the melting line 11 and/or by the rolling line 21, and select one, the other, or both in order to supply electric energy to the melting line 11 and/or to the rolling line 21 at least as a function of the respective operating status and the overall energy costs.

The use of the power compensation system 50 connected to the control system 41 allows to obtain a dynamic system for compensating the disturbances concerning the power absorbed by the furnace 12 and/or by the user devices 17, 18, 19, so as to control and compensate for the moments of inconstant absorption by the furnace 12 and/or by the user devices 17, 18, 19.

In particular, the storage system 29 is therefore able to store and supply the energy coming from the at least one alternative energy source 40 or possibly from the electric network 15 when it is not used by the main user devices, such as the furnace 12 and/or the user devices 17, 18, 19.

By means of this storage system 29, it is therefore possible to store energy during power-off phases of the furnace 12, so as to be able to make the alternative energy sources 40, and in particular the renewable energy sources 25, work with consistency.

In fact, it is known that renewable energy sources 25 have minimum times to be respected for power-on and reaching steady-state operation, therefore it is not efficient to make them work in an “On-Off” manner. Instead, it is preferable and advantageous to use the storage system 29 as a sort of buffer which allows them to work with variable productivity.

The energy stored by the storage system 29, for example during moments of continuous power-off of the furnace 12, can be destined for other uses, such as for example the power supply of another user device 42, in particular external to the steel plant 20.

According to some embodiments, it can also be provided that the energy supplied by the electric network 15 or even more by the alternative energy source(s) 40 is directly diverted from the furnace 12 and/or from the user devices 17, 18, 19 toward the user device 42.

This user device 42 can be an electrolytic cell or electrolyser configured to produce hydrogen and send it to a reactor 43 configured to produce hot Direct Reduced Iron (DRI) 46, while the resulting oxygen can be used in a known manner in the steel plant. As a charge, the reactor 43 receives for example ferrous minerals. The pre-reduced iron 46 is used as a charge in the furnace 12.

The reactor 43 is also configured to produce pre-reduced iron 44 which is cooled for future use, and/or pre-reduced iron suitable to be briquetted 45 in order to be stored and used at a later time, for example.

According to possible embodiments, not shown, the other user device 42 could also be a heating device, or a device suitable to lift loads, for example to store potential energy which can subsequently be converted into kinetic energy and therefore recovered when necessary.

By providing a power compensation system 50 comprising at least one of either the storage system 29 or another user device 42, the alternative energy sources 40, in particular the renewable energy sources 25, can be used continuously, even if not directly in the production of steel; at the same time, when the steel plant 20 requires power, this will be supplied immediately by the storage system 29 which, in the meantime, has been recharged.

FIG. 2 exemplifies how, in a melting with multiple charge, for example with three baskets, there are different phases F1, F2, F3, F4, F5, F6 in which there is no need for power, and other phases F7, F8, F9 in which the power demand undergoes high fluctuations, corresponding in particular to the phases of drilling the layers of scrap introduced during melting.

According to some embodiments, the method according to the invention provides to control the operation of the furnace 12 and/or of the one or more user devices 17, 18, 19 on the basis of a predefined operating model that defines at least one or more operating phases, possible shutdown instants and the electrical power required in the one or more operating phases.

According to another aspect of the present invention, the method provides to progressively divert the energy supplied to the furnace 12 and/or to one or more user devices 17, 18, 19 toward the power compensation system 50.

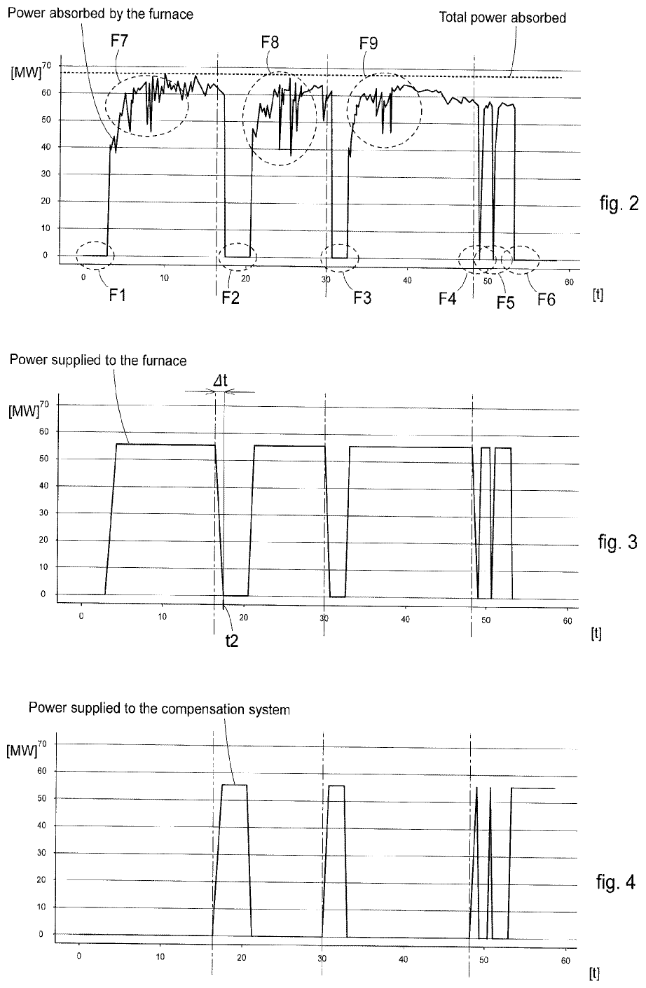

When the furnace 12 is for example in a phase F7, F8 or F9 of the process in which the drawing of power is required, the power produced by the network 15 and/or by the renewable energy source 25 is directed to the furnace 12 according to requirements, see also FIG. 3.

When, on the other hand, the melting process does not require power, phases F1, F2, F3, F4, F5 or F6, for example during the unloading of the baskets into the furnace 12, or during tapping, maintenance or other, the power produced by the network 15 and/or by the renewable energy source 25 is directed toward the power compensation system 50, for example the storage system 29, FIG. 4.

For example, if in a phase F2 of the process the power supplied to the furnace 12 goes to zero, the power demand to the network 15 will remain almost constant and this power will be diverted toward the storage system 29 or to the other user device 42, or other. In this way, the overall power absorbed by the steel plant 20 from the side of the electric network 15 remains constant, regardless of the process phases.

According to some embodiments, the method according to the invention provides to progressively divert the energy supplied to the at least one furnace 12 and/or to the one or more user devices 17, 18, 19 toward the power compensation system 50.

In the case of continuous casting, where phases F1-F9 are substantially known in the design phase, it is also possible to make the power ramp-ups and ramp-downs less steep by using the power compensation system 50, for example by intervening in advance to divert power to such system or to draw some of the power from such system.

These ramps can also be modified in real time by the control system 41 on the basis of a comparison between the real trend of the melting or rolling process in progress with respect to the predefined model, for example carried out on the basis of position/speed/temperature data or other parameters of the product being worked, gathered by means of a plurality of suitably positioned sensors.

In particular, according to some embodiments, the method provides to start to divert the energy supplied to the furnace 12 and/or to the user devices 17, 18, 19 at a determinate time interval Δt in advance of one or each of the shutdown instants. FIG. 3, for example, highlights the instant t2 in which the power supplied to the furnace 12 is equal to zero in order to be able to proceed with loading a basket. As can be seen, the power supplied to the furnace 12 begins to decrease at a time interval Δt in advance of this instant t2. At the same time, at the instant t2−Δt the power supplied to the power compensation system 50 begins to increase.

The interval can be substantially constant for the different phases of a given process, or also variable, for example defined as a function of the total amount of power absorbed by the respective furnace 12 and/or user device 17, 18, 19, the type of metal and/or the type of product being worked.

According to another aspect of the present invention, the method provides to decrease the energy supplied to the furnace and/or to the user devices 17, 18, 19 according to a predefined ramp-down, and at the same time increase the energy supplied to the compensation system 50 according to a ramp-up that has a trend that is the same and opposite to the ramp-down. In this way, their sum remains substantially constant.

According to some embodiments, it can be provided that the ramp-ups and ramp-downs of the trend of the energy supplied to the furnace 12 or to the power compensation system 50, respectively, are substantially rectilinear, or that they can in turn be divided into sub-phases, each one with its own trend.

According to some embodiments, it can also be provided that, in the event that the shutdown instants of two or more of either the furnace 12 or the user devices 17, 18, 19 are close to each other, the control system 41 provides to define respective ramp-downs for each of them, and one or more corresponding ramp-ups, dividing the energy in such a way as to keep the overall value of absorbed power substantially constant.

It is also possible to provide that a percentage of the power absorbed from the network 15 is directed toward the furnace 12 and/or the user devices 17, 18, 19 which require it, and that the remaining part is directed or diverted toward the power compensation system 50, so as to keep the power absorbed from the network 15 constant.

In the event the alternative energy source 40 is used, the storage system 29 also allows to prevent the demand for power from the alternative energy source 40 from having an excessively oscillatory trend; moreover, the alternative energy source 40 is used for practically all the availability that it can supply.

The supply of power by the storage system 29 is managed in such a way as to minimize the power oscillations on the absorption side, that is, phases F7, F8, F9. By means of the control system 41, when a power absorption is detected that is particularly onerous compared to previous instants, the storage system 29 comes into play, releasing the power sufficient to compensate for this need, thus allowing a damping of a peak in the undulatory trend of the power absorbed over time.

The storage system 29 can also intervene when the power delivered by the alternative energy source 40 is not sufficient for a certain phase of the process.

It is clear that modifications and/or additions of parts may be made to the method and apparatus for supplying electric energy as described heretofore, without departing from the field and scope of the present invention, as defined by the claims.

It is also clear that, although the present invention has been described with reference to some specific examples, a person of skill in the art will be able to achieve other equivalent forms of method and apparatus for supplying electric energy to a steel plant, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. Method for supplying electric energy in a steel plant, comprising at least one of either a furnace for melting metal material or one or more user devices that use the metal material obtained from said at least one furnace which are electrically powered by means of power supply means comprising at least one transformer connected to an electric network and a power supply system located downstream of said transformer, wherein said method provides to:
controlling, by means of a control system, the power absorbed from said electric network by said at least one furnace and/or by said one or more user devices; and
electrically connecting said power supply system to a power compensation system comprising at least one storage system and at least one other user device, and configured to absorb at least part of the energy delivered by said electric network when said furnace and/or said one or more user devices require, from said electric network, a power lower than a given value, in order to keep the power absorbed from said electric network within a range of the given value, then absorb the possible excess energy delivered by said electric network.

2. Method as in claim 1, wherein said at least one furnace is part of at least one melting line and said one or more user devices are part of a rolling line.

3. Method as in claim 1, wherein said storage system is electrically connected to a common bus associated with direct current connection systems electrically connected to said at least one furnace and/or to said one or more user devices.

4. Method as in claim 1, wherein electric energy is supplied to said at least one furnace and/or to said one or more user devices by means of at least one alternative energy source, different and independent from said electric network.

5. Method as in claim 4, further comprising supplying, by means of said power compensation system, at least an amount of power to said at least one furnace and/or to said one or more user devices so as to integrate the power supplied by said at least one alternative energy source.

6. Method as in claim 1, wherein said other user device is an electrolyzer configured to produce hydrogen and send it to a reactor configured to produce Direct Reduced Iron.

7. Apparatus for supplying electric energy in a steel plant comprising at least one of either a furnace for melting metal material or one or more user devices that use the metal material obtained from said at least one furnace which are electrically powered by means of power supply means comprising at least one transformer connected to an electric network and a power supply system located downstream of said transformer, wherein said apparatus comprises a control system configured to control the power absorbed by said at least one furnace and/or said one or more user devices and a power compensation system comprising at least one storage system and at least one other user device, said power compensation system being electrically connected to said power supply system and configured to absorb energy when said furnace and/or said one or more user devices require a power lower than a given value, then absorb the possible excess energy delivered by said electric network.

8. Apparatus as in claim 7, wherein said storage system is provided with one or more storage devices connected to said common bus by means of a corresponding high frequency converter.

9. Apparatus as in claim 8, wherein said storage system is static and said storage devices comprise batteries, fuel cells, supercapacitors or suchlike.

10. Apparatus as in claim 8, wherein said storage system is dynamic and said storage devices comprise flywheel energy storage batteries, turbogenerators powered by renewable fuels such as palm oil, mini-hydro turbines or suchlike.

11. Steel plant, comprising at least one apparatus as in claim 7, at least one furnace for melting metal material and one or more user devices that use the metal material obtained from said at least one furnace.
